(19) United States
(12) Patent Application Publication
(10) Pub. No.: US 2026/0312503 A1
(43) Pub. Date: Oct. 8, 2026

(54) A METHOD OF OPERATING A DC/DC CONVERTER

(71) Applicant: BRUSA HYPOWER AG, Buchs (CH)

(72) Inventors: Michael Leibl, Buchs (CH); Lukas Riegler, Buchs (CH); Vladan Lazarevic, Buchs (CH)

(21) Appl. No.: 19/481,749

(22) PCT Filed: May 6, 2024
(86) PCT No.: PCT/EP2024/062434

§ 371 Date: Nov. 5, 2025

(30) Foreign Application Priority Data
May 12, 2023 (DE) 10 2023 112 596.6

(51) Int. Cl. H02M 3/335; H02M 1/34

(52) U.S. Cl. CPC H02M 3/33573; H02M 1/342; H02M 3/33576

(57) ABSTRACT

A method of operating a DC/DC converter, wherein the DC/DC converter comprises a primary side, a secondary side, and a transformer with a centre tap, wherein an upper transformer tap and a lower transformer tap are connected via a full-bridge circuit with upper switches onto an upper terminal point of a snubber capacitance and with lower switches onto a lower terminal point of the snubber capacitance, a lower secondary-side DC terminal is connected onto the lower terminal point of the snubber capacitance and an upper secondary-side DC terminal is connected onto the centre tap via a filter inductance wherein, in an operating state, the upper switches in an alternating manner apply positive voltage pulses of a secondary voltage to between the centre tap and the upper terminal point of the snubber capacitance, wherein between the voltage pulses the upper switches are closed and the lower switches are opened.

### CROSS REFERENCE TO RELATED APPLICATIONS

The present application is the U.S. National Phase of PCT/EP2024/062434, filed on 6 May 2024, which claims priority to German Patent Application No. 10 2023 112 596.6, filed on 12 May 2023, the entire contents of which are incorporated herein by reference.

### BACKGROUND

### Field

The invention relates to the field of electronic power converters. It relates to a method of operating a DC/DC converter, to a control unit for a DC/DC converter, as well as to a DC/DC converter, according to the preamble of the respective independent patent claims.

### Related Art

The market for power electronics places high demands on DC/DC converters of high voltage (HV) to low voltage (LV) and with a low power, for example about 3 kW, such being used for the supply of low-voltage batteries. The voltage of such low-voltage batteries typically lies in the range of 10.5 V to 15.5 V. The converter must operate over a wide input voltage range, where possible without a reduction of power. Furthermore, a very low price of the product with as many features as possible is preferred. The manufacturers of electric vehicles tend to increase the voltage of high-voltage batteries, and different customers can demand different input voltage levels. Starting with today's battery voltages of 400 V, battery voltages of 600 V to 800 V will establish themselves as a new standard. Corresponding DC/DC converters should cover as large as possible voltage range, in order to be able to be used comprehensively.

FIG. 1 shows a structure of such a DC/DC converter from a primary-side input voltage Vp to a secondary-side output voltage Vs. Two full-bridges 19, 40 which are coupled by a transformer 3 are to be seen therein. The transmitted power is controlled by way of an intermittent application of a voltage at the primary side of the transformer. The output voltage is closed-loop controlled by way of the ratio of the switch-on time and switch-off time (duty cycle) of this voltage at the primary side. Two lower switches S6 and S8 at the secondary side serve for the rectification of the voltage which is applied to the transformer and for short-circuiting the secondary transformer windings in a freewheeling state. FIG. 2A shows exemplary wave shapes with a duty cycle of 25%. Two upper switches S5 and S7 of the secondary side are only used as snubbers (dampers) for high voltage peaks at the secondary side, such voltage peaks arising due to the leakage inductance of the transformer. In the steady state, the voltage at the centre tap 39 of the transformer 3 is equal to the secondary-side output voltage, i.e., it is the case that <v_{ct}>Vs. The DC input transfer function/output transfer function M(d) is herewith given by

$$M ( d ) = \frac{{V}_{s}}{{V}_{p}} = 2 \frac{{N}_{s}}{{N}_{p}} d = \frac{2}{n} d$$

wherein n is the transformation ratio of the transformer and d the primary-side duty cycle, with 0<d<0.5. With this known closed-loop control method, the maximal output voltage s is limited to Vp/n. If one assumes a fixed output voltage, as is common given the application of the converter since it is loaded by a low-voltage battery, the input voltage range is accordingly also limited.

### SUMMARY

It is therefore the object of the invention to provide a method of operating a DC/DC converter, a control unit for a DC/DC converter, as well as a DC/DC converter, of the initially mentioned type, which permit a broader field of application. Herewith, in particular, it should be possible to operate with a larger range of input voltages with a given voltage at the output side.

This object is achieved by a method of operating a DC/DC converter, a control unit for a DC/DC converter, as well as a DC/DC converter, with the features of the respective independent patent claims.

The method serves for operating a DC/DC converter, wherein the DC/DC converter comprises a primary side, a secondary side, and a transformer With a centre tap, wherein an upper transformer tap and a lower transformer tap are connected via a full-bridge circuit with upper switches onto an upper terminal point of a snubber capacitance and with lower switches onto a lower terminal point of the snubber capacitance, a lower secondary-side DC terminal is connected onto the lower terminal point of the snubber capacitance and an upper secondary-side DC terminal is connected onto the centre tap via a filter inductance.

Herein, in a first operating state the lower switches in an alternating manner and with a duty cycle d between zero and 0.5 apply positive voltage pulses of the secondary voltage to between the centre tap and the lower secondary-side DC terminal, wherein between these voltage pulses the lower switches are closed and the upper switches divert currents, which on switching off the lower switches would lead to voltage peaks, into the snubber capacitance.

In a second operating state, the upper switches in an alternating manner apply positive voltage pulses of the secondary voltage to between the centre tap and the upper terminal point of the snubber capacitance, wherein between the voltage pulses the upper switches are closed and the lower switches are opened.

Thus, in the second operating state when the transformer is without current at the primary side, the first upper switch and the second upper switch are closed, and by way of this the voltage at the centre tap is clamped onto voltage at the first terminal point of the snubber capacitance.

On account of the upper switches being closed between the voltage pulses in the second operating state, the voltage at the upper secondary-side DC terminal is formed starting from the voltage at the snubber capacitance. By way of this, the voltage range which as a whole can be covered by the output voltage is doubled. This doubling relates to the maximal voltage which can be achieved with the first operating state, wherein the lower switches remain closed and the duty cycle is limited to 0.5.

In embodiments, in the second operating state in each case subsequently to the application of a voltage pulse by way of closing one of the upper switches, this upper switch is opened again in order to limit a discharging of the snubber capacitance.

Thus, it is achieved that the voltage across the snubber capacitance starts to oscillate.

The method of operating a DC/DC converter is hereinafter described with a much higher degree of detail: the DC/DC converter comprises a primary side, a secondary side, and a transformer, wherein
the transformer comprises a secondary-side upper transformer tap, lower transformer tap, and a centre tap,
the secondary side comprises a lower secondary-side DC terminal and an upper secondary-side DC terminal,
a filter inductance is connected between the upper secondary-side DC terminal and the centre tap,
a first upper switch is connected between the upper transformer tap and a first terminal point of a snubber capacitance whose second terminal point is connected onto the lower secondary-side DC terminal,
a second upper switch is connected between the lower transformer tap and the first terminal point of the snubber capacitance,
a first lower switch is connected between the upper transformer tap and the lower secondary-side DC terminal, and
a second lower switch is connected between the lower transformer tap and the lower secondary-side DC terminal,
wherein each of the switches comprises a freewheeling diode.

Herein, it is the case that in an enhanced operating state, the DC/DC converter repeatedly runs through the following states in this sequence:
first state: the transformer is without current at the primary side, the first upper switch and the second upper switch are closed, the first lower switch and the second lower switch are opened;
second state: the transformer generates a positive voltage at the upper transformer tap with respect to the lower transformer tap, the second upper switch is opened and the second lower switch is closed;
third state: the first upper switch is opened;
fourth state: the transformer is switched to currentless at the primary side, the first upper switch and the second upper switch are closed and the second lower switch is opened;
fifth state: the transformer at the upper transformer tap generates a negative voltage with respect to the lower transformer tap, the first upper switch is opened and the first lower switch is closed; and
sixth state: the second upper switch is opened.

The third and sixth states are optional, which is to say that they are skipped in embodiments.

In embodiments, the time duration during which the first state and/or fourth state is active is

$${T}_{on 1 - S 5 S 7} = \frac{2 d - 1}{2 {f}_{sw}}$$

wherein d is a duty cycle of the DC/DC converter and 0.5<d<l, and f_{sw} is the switching frequency, i.e., the frequency with which the cycle is repeated over the six states.

In embodiments, the time duration during which the second state and/or the fifth state is active is

$${T}_{half \_ period} = 0.5 {T}_{res} = \frac{2 π \cdot \sqrt{( \frac{2 {L}_{lp}}{{n}^{2}} + {L}_{ls 1} + {L}_{ls 2} ) \cdot {C}_{snubber}}}{2}$$

wherein n is the winding ratio of the primary winding to in each case one of the secondary windings, Lₗₚ is the leakage inductance of the primary winding, Lₗₛ₁ and Lₗₛ₂ the leakage inductances of the secondary windings, and C_{snubber} the capacitance of the snubber capacitance.

In embodiments, the transmitted power is reduced given a duty cycle above 0.5. In embodiments, the transmitted power is reduced by way of the output current being reduced. Herewith, the method can be implemented on existing circuit hardware and the transmittable voltage ratio can be increased without the hardware having to be modified.

The control unit according to the invention for a DC/DC converter is programmed to carry out the method according to one of the patent claims. The control unit further comprises sensors for detecting currents and/or voltages in the DC/DC converter, as well as control stages for controlling the switches of the DC/DC converter. The DC/DC converter according to the invention comprises such a control unit.

A computer program for operating the control unit for a DC/DC converter according to the invention can be loaded into an internal memory of a digital data processing unit of the control unit and comprises computer program code means which, when they are implemented in the control unit, bring this into carrying out the method according to the invention. In a preferred embodiment of the invention, a computer program product comprises a data carrier which is to say a computer-readable medium, on which the computer program code means are stored.

Further preferred embodiments are to be derived from the dependent patent claims. Herein, features of the method claims with regard to context can be combined with the device claims and vice versa.

### BRIEF DESCRIPTION OF THE DRAWINGS

The subject-matter of the invention is hereinafter explained in more detail by way of preferred embodiment examples which are represented in the accompanying drawings. In each case shown schematically are:

FIG. 1 the structure of a DC/DC converter;

FIG. 2A primary-side and secondary-side voltage courses in a first operating state of the DC/DC converter;

FIG. 2B primary-side and secondary-side voltage courses in a second operating state of the DC/DC converter;

FIG. 2C relations between duty cycles and output voltage;

FIG. 3 signal courses in the second operating state; and

FIG. 4 a reduction of the transmitted power in the second operating state.

Basically, in the figures, the same or equally acting parts are provided with the same reference numerals.

### DETAILED DESCRIPTION

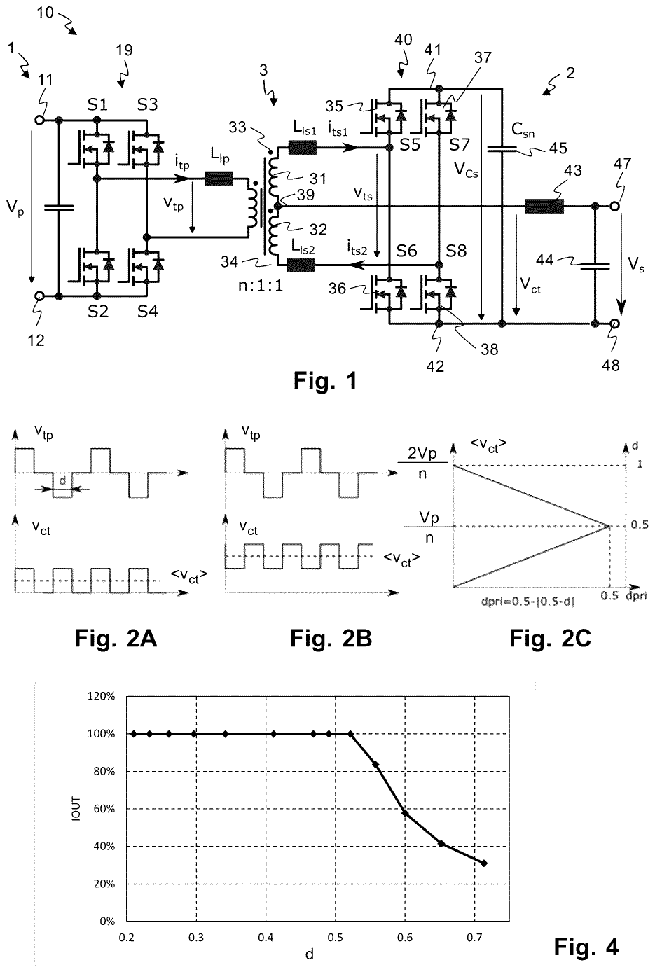

FIG. 1 shows the structure of a DC/DC converter. The DC/DC converter 10 comprises a primary side 1, a secondary side 2, and a transformer 3. The primary side 1 comprises an upper primary-side DC terminal 11 and a lower primary-side DC terminal 12, via which terminals a primary-side bridge circuit 19 is fed, said bridge circuit applying voltage impulses onto the primary side of the transformer 3.

The transformer 3 comprises an upper secondary winding 31 and a lower secondary winding 32, with a secondary-side upper transformer tap 33, lower transformer tap 34, and centre tap 39.

The secondary side 2 comprises a lower secondary-side DC terminal 48 and an upper secondary-side DC terminal 47, wherein a filter inductance 43 is connected between the upper secondary-side DC terminal 47 and the centre tap 39. A secondary-side bridge circuit 40 comprises:
a first upper switch 35 which is connected between the upper transformer tap 33 and a first terminal point of a snubber capacitance 45 whose second terminal point is connected onto the lower secondary-side DC terminal 48,
a second upper switch 37 which is connected between the lower transformer tap 34 and the first terminal point of the snubber capacitance 45,
a first lower switch 36 which is connected between the upper transformer tap 33 and the lower secondary-side DC terminal 48, and
a second lower switch 38 which is connected between the lower transformer tap 34 and the lower secondary-side DC terminal 48,

wherein each of the switches 35, 36, 37, 38 comprises a freewheeling diode.

The lower secondary-side DC terminal 48 and the upper secondary side DC terminal 47 are connected to one another by a filter capacitance 44, i.e., the filter capacitance 44 is connected between the lower secondary-side DC terminal 48 and the upper secondary-side DC terminal 47.

FIG. 2A shows primary-side and secondary-side voltage courses in a first operating state of the DC/DC converter. This corresponds to a conventional control of the DC/DC converter. In the steady state, the voltage at the output choke, averaged over the switching period, is equal to zero, so that the output voltage vs of the DC/DC converter is equal to the averaged centre tap voltage <vCt>. Concerning the known hard-switched closed-loop control method, the mean average voltage is closed-loop controlled by setting the duty cycle d of the primary voltage, as is represented in FIG. 2A. In the state of the art, both Low-Side MOSFETs (S6, S8) of the secondary side 2, i.e., the first lower switch 36 and the second lower switch 38, are switched on in the freewheeling state.

FIG. 2B shows primary-side and secondary-side voltage courses in a second operating state of the DC/DC converter. Here, both High-Side MOSFETS (S5, S7) of the secondary side 2 are switched on, i.e., the first upper switch 35 and the second upper switch 37 (this is in contrast to the state of the art, according to which the two upper switches are switched just as on the primary side). Different voltage wave shapes result at the centre tap, depending on which MOSFETSs (Low-side or High-side) are used during the freewheeling (FIG. 2A and FIG. 2B, respectively). The use of the second operating state (“High-Side” freewheeling) therefore permits an increase of the output voltage range, and the snubber capacitance 45 is also used as an energy buffer in this operating state.

FIG. 2C shows relations between duty cycles and output voltage or the averaged centre tap voltage <vCt>.
For output voltages between zero and Vp/n, the DC/DC converter is operated in the first operating state. The duty cycle of the primary side dpri is equal to a duty cycle d of the DC/DC converter and assumes values between zero and 0.5.

For output voltages between VP/n and 2Vp/n, the DC/DC converter is operated in the second operating state. The duty cycle of the primary side dpri is equal to 0.5−|0.5−d|, wherein d assumes values between 0.5 and 1. The duty cycle d of the DC/DC converter sets the ratio between the output voltage and the maximal output voltage.

The limitation of the duty cycle d of the DC/DC converter is therefore lifted, as it is present in FIG. 2C on the left y-axis. If the value of the duty cycle is to lie above 0.5, then the upper switches (first upper switch 35 and second upper switch 37) are used during the freewheeling, in order to short circuit the secondary windings of the transformer. Herewith, the maximal average centre tap voltage of up to 2Vp/n can be applied. At the primary side, the duty cycle remains in the initial range, i.e. 0<dpri<0.5. In contrast, the range of the duty cycle and of the secondary-side duty cycle is now 0<d<1, and the relationship between dpri and d is given by

$${d}_{pri} = 0.5 - \vert 0.5 - d \vert .$$

The charging time of the snubber capacitance 45 is preferably limited according to the values of the leakage inductances (Llp, Lls1, Lls1) of the transformer 3 and of the snubber capacitance 45, in order to minimise the effective current of the power transistors S5 and S7. During the active primary state, the respective secondary switch S5 or S7 is switched on for half the resonance time. This time is computed as follows:

$${T}_{half \_ period} = 0.5 {T}_{res} = \frac{2 π \cdot \sqrt{( \frac{2 {L}_{lp}}{{n}^{2}} + {L}_{ls 1} + {L}_{ls 2} ) \cdot {C}_{snubber}}}{2}$$

The switches S5 and S7 are also active during the freewheeling, in order to clamp the centre tap onto the voltage of the snubber capacitance 45 and thus permit an output voltage B which is higher than Vp/n.

In the state of freewheeling, the snubber capacitance 45 is discharged by the current of the filter inductance 43. For this reason, the switch-on time for both switches S5 and S7 is subdivided into two sections. A part of the time (T_{on1-S5S7}) can be computed based on the necessary duty cycle, i.e., how long the switches need to clamp the centre tap onto the snubber capacitance voltage:

$${T}_{on 1 - S 5 S 7} = \frac{2 d - 1}{2 {f}_{sw}}$$

As already explained, a further part of the time (T_{on2-S5S7}) is based on the oscillation circuit period during the snubber time interval in which the snubber capacitance is charged:

$${T}_{on 2 - S 5 S 7} = {T}_{half \_ period}$$

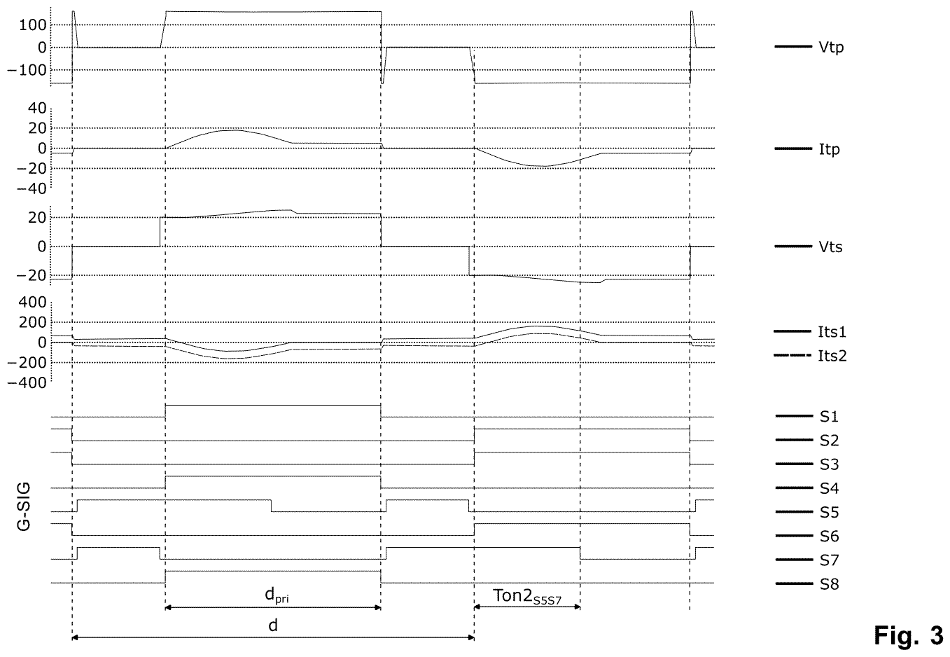

FIG. 3 shows signal courses in the second operating state, i.e., the PWM signals and the wave shapes of the transformer. It is assumed that the period begins when S2 and S3 are switched off which is represented in FIG. 3 at the left side. The switch S5 is switched on for the time T_{on1-S5S7}+T_{on2-S5S7} and S7 only for the time T_{on1-S5S7}. S5 is subsequently switched off, in order to prevent the current of the snubber capacitance 45 from oscillating and discharging the snubber capacitance 45. At the beginning of the second half-period, S5 must be switched on again, but only for the time interval T_{on1-S5S7}, in order to short circuit the transformer during the freewheeling interval. S7 also needs to be switched on at this point in time, for the time T_{on1-S5S7}+T_{on2-S5S7}. S7 remains switched off for the remainder of the half period. The period then ends and begins anew with the switching-on of S5 and S7. In FIG. 3, the value of d is about 0.6 and the value of d-pri about 0.4.

In embodiments, the snubber capacitance 45 is sufficiently large and one can make do without switching off S5 or S7 respectively, which would be necessary in order to prevent the current of the snubber capacitance 45 from switching and discharging the snubber capacitance 45. In particular, this is possible in situations where the DC/DC converter from the very beginning is designed to be operated in the second operating state.

Regarding DC/DC converters which are not first and foremost designed to be operated in the second operating state, the switches S5 and S7 as a rule are not designed for a high current loading capacity. It is due to this restriction of the applied switches that given such converters, a de-rating for the output power needs to be implemented, depending on the duty cycle cd. This means that above a certain duty cycle, the transmitted power is reduced. By way of this, the possible output voltage range can be increased at full power up to this duty cycle, and as a whole a significantly larger output voltage range can be achieved, even if at a reduced power.

FIG. 4 shows such a lowering of the transmitted power in the second operating state, beginning at a duty cycle of somewhat about 0.5. The precise value, above which the power is to be reduced and the degree of reduction are determined based on the specific parameters of the DC/DC converter, so that the allowable operating parameters of the components are not exceeded.

Hence at a given output voltage, the region of input voltages with which a given DC/DC converter can be operated can be increased by the second operating state, without changes on the hardware of the DC/DC converter being necessary.

For example, given an output voltage of 14 V, the input voltage range can be expanded from 200 V-400 V to 125 V-400 V.

### LIST OF REFERENCE NUMERALS

1 primary side
2 secondary side
3 transformer
10 DC/DC converter
11 upper primary-side DC terminal
12 lower primary-side DC terminal
19 primary-side bridge circuit
31 upper secondary winding
32 lower secondary winding
33 upper transformer tap
34 lower transformer tap
35 first upper switch
36 first lower switch
37 second upper switch
38 second lower switch
39 centre tap
40 secondary-side bridge circuit
41 upper connection rail
42 lower connection rail
43 filter inductance
44 filter capacitance
45 snubber capacitance
47 upper secondary-side DC terminal
48 lower secondary-side DC terminal

1. A method of operating a DC/DC converter, wherein the DC/DC converter comprises a primary side, a secondary side and a transformer with a centre tap, wherein an upper transformer tap and a lower transformer tap are connected via a full-bridge circuit with upper switches onto an upper terminal point of a snubber capacitance and with lower switches onto a lower terminal point of the snubber capacitance, a lower secondary-side DC terminal is connected onto the lower terminal point of the snubber capacitance and an upper secondary-side DC terminal is connected onto the centre tap via a filter inductance, wherein the method comprises:
in a first operating state the lower switches in an alternating manner and with a duty cycle d of between zero and 0.5 applying positive voltage pulses of a secondary voltage to between the centre tap and the lower secondary-side DC terminal,
wherein between these voltage pulses the lower switches are closed and the upper switches, divert currents which on switching off the lower switches would lead to voltage peaks, into the snubber capacitance; and
in a second operating state the upper switches in an alternating manner applying positive voltage pulses of the secondary voltage to between the centre tap and the upper terminal point of the snubber capacitance,
wherein between the voltage pulses the upper switches are closed and the lower switches are opened.

2. The method according to claim 1, wherein in the second operating state in each case subsequently to the application of a voltage pulse by way of one of the upper switches, opening a respective upper switch in order to limit a discharging of the snubber capacitance.

3. The method according to claim 1, wherein:
the transformer comprises a secondary-side tipper transformer tap, a lower transformer tap, and a centre tap,
the secondary side comprises a lower secondary-side DC terminal and an tipper secondary-side DC terminal,
a filter inductance is connected between the upper secondary-side DC terminal and the centre tap,
a first upper switch is connected between the upper transformer tap and a first terminal point of a snubber capacitance whose second terminal point is connected onto the lower secondary-side DC terminal,
a second tipper switch is connected between the lower transformer tap and the first terminal point of the snubber capacitance,
a first lower switch is connected between the tipper transformer tap and the lower secondary-side DC terminal, and
a second lower switch is connected between the lower transformer tap and the lower secondary-side DC terminal,
wherein each of the lower switches and the upper switches comprises a freewheeling diode,
wherein in an enhanced operating state the DC/DC converter repeatedly running through the following states in this sequence:
first state: the transformer is without current at the primary side, the first upper switch and the second upper switch are closed, the first lower switch and the second lower switch are opened;
second state: the transformer generates a positive voltage at the upper transformer tap with respect to the lower transformer tap, the second upper switch is opened, and the second lower switch is closed;
optional third state: the first upper switch is opened;
fourth state: the transformer is switched to currentless at the primary side, the first upper switch and the second upper switch are closed, and the second lower switch is opened;
fifth state: the transformer at the upper transformer tap generates a negative voltage with respect to the lower transformer tap, the first upper switch is opened, and the first lower switch is closed; and
optional sixth state: the second upper switch is opened.

4. The method according to claim 3, wherein a time duration during which the first state and/or fourth state is active is
$${T}_{on 1 - S 5 S 7} = \frac{2 d - 1}{2 {f}_{sw}}$$
wherein d is a duty cycle of the DC/DC converter and 0.5<d<1, and f_{sw} is the switching frequency; with which the cycle is repeated over the six states.

5. The method according to claim 3, wherein a time duration during which the second state and/or the fifth state is active is
$${T}_{half \_ period} = 0.5 {T}_{res} = \frac{2 π \cdot \sqrt{( \frac{2 {L}_{lp}}{{n}^{2}} + {L}_{ls 1} + {L}_{ls 2} ) \cdot {C}_{snubber}}}{2}$$
wherein n is a winding ratio of a primary winding to in each case one of secondary windings, Lₗₚ is a leakage inductance of the primary winding, Lₗₛ₁ and Lₗₛ₂ are a leakage inductances of the secondary windings, and C_{snubber} is a capacitance of the snubber capacitance.

6. The method according to claim 1, wherein the method comprises reducing a transmitted power given a duty cycle above 0.5.

7. The method according to claim 6, wherein the method comprises reducing the transmitted power by way of an output current being reduced.

8. A programmed controller for a DC/DC converter, wherein the DC/DC converter comprises a primary side, a secondary side, and a transformer with a centre tap, wherein an upper transformer tap and a lower transformer tap are connected via a full-bridge circuit with upper switches onto an upper terminal point of a snubber capacitance and with lower switches onto a lower terminal point of the snubber capacitance, a lower secondary-side DC terminal is connected onto the lower terminal point of the snubber capacitance and an upper secondary-side DC terminal is connected onto the centre ta via a filter inductance, wherein the controller controls:
in a first operating state the lower switches in an alternating manner and with a duty cycle d of between zero and 0.5 to apply positive voltage pulses of a secondary voltage to between the centre tap and the lower secondary-side DC terminal,
wherein between these voltage pulses the lower switches are closed and the u er switches divert currents which on switching off the lower switches would lead to voltage peaks, into the snubber capacitance; and
in a second operating state the upper switches in an alternating manner to apply positive voltage pulses of the secondary voltage to between the centre tap and the upper terminal point of the snubber capacitance,
wherein between the voltage pulses the upper switches are closed and the lower switches are opened.

9. The DCDC converter with the controller according to claim 8.

10. A DC/DC converter comprising a primary side, a secondary side, and a transformer with a centre tap, wherein an upper transformer tap and a lower transformer tap are connected via a full-bridge circuit with upper switches onto an upper terminal point of a snubber capacitance and with lower switches onto a lower terminal point of the snubber capacitance, a lower secondary-side DC terminal is connected onto the lower terminal point of the snubber capacitance and an upper secondary-side DC terminal is connected onto the centre tap via a filter inductance, wherein:
in a first operating state the lower switches in an alternating manner and with a duty cycle d of between zero and 0.5 apply positive voltage pulses of a secondary voltage to between the centre tap and the lower secondary-side DC terminal,
wherein between these voltage pulses the lower switches are closed and the upper switches divert currents which on switching off the lower switches would lead to voltage peaks, into the snubber capacitance; and
in a second operating state the upper switches in an alternating manner apply positive voltage pulses of the secondar voltage to between the centre ta and the upper terminal point of the snubber capacitance,
wherein between the voltage pulses the upper switches are closed and the lower switches are opened.

11. The DC/DC converter according to claim 10, wherein the snubber capacitance comprises an amount of capacitance configured so that switch-off procedures which would be necessary in order to prevent the current of the snubber capacitance from oscillating and discharging the snubber capacitance are not necessary.

12. The DC/DC converter according to claim 10, wherein in the second operating state in each case subsequently to the application of a voltage pulse by way of one of the upper switches, a respective upper switch is opened in order to limit a discharging of the snubber capacitance.

13. The DC/DC converter according to claim 10, wherein:
the transformer comprises a secondary-side upper transformer tap, a lower transformer tap, and a centre tap,
the secondary side comprises a lower secondary-side DC terminal and an upper secondary-side DC terminal,
a filter inductance is connected between the upper secondary-side DC terminal and the centre tap,
a first upper switch is connected between the upper transformer tap and a first terminal point of a snubber capacitance whose second terminal point is connected onto the lower secondary-side DC terminal,
a second upper switch is connected between the lower transformer tap and the first terminal point of the snubber capacitance,
a first lower switch is connected between the upper transformer tap and the lower secondary-side DC terminal, and
a second lower switch is connected between the lower transformer tap and the lower secondary-side DC terminal,
wherein each of the lower switches and the upper switches comprises a freewheeling diode,
wherein in an enhanced operating state the DC/DC converter repeatedly runs through the following states in this sequence:
first state: the transformer is without current at the primary side, the first upper switch and the second upper switch are closed, the first lower switch and the second lower switch are opened;
second state: the transformer generates a positive voltage at the upper transformer tap with respect to the lower transformer tap, the second upper switch is opened, and the second lower switch is closed;
optional third state: the first upper switch is opened;
fourth state: the transformer is switched to currentless at the primary side, the first upper switch and the second upper switch are closed, and the second lower switch is opened;
fifth state: the transformer at the upper transformer tap generates a negative voltage with respect to the lower transformer tap, the first upper switch is opened, and the first lower switch is closed; and
optional sixth state: the second upper switch is opened.

14. The DC/DC converter according to claim 13, wherein a time duration during which the first state and/or fourth state is active is
$${T}_{on 1 - S 5 S 7} = \frac{2 d - 1}{2 {f}_{sw}}$$
wherein d is a duty cycle of the DC/DC converter and 0.5<d<l, and f_{sw} is the switching frequency with which the cycle is repeated over the six states.

15. The DC/DC converter according to claim 13, wherein a time duration during which the second state and/or the fifth state is active is
$${T}_{half \_ period} = 0.5 {T}_{res} = \frac{2 π \cdot \sqrt{( \frac{2 {L}_{lp}}{{n}^{2}} + {L}_{ls 1} + {L}_{ls 2} ) \cdot {C}_{snubber}}}{2}$$
wherein n is a winding ratio of a primary winding to in each case one of secondary windings, Lₗₚ is a leakage inductance of the primary winding, Lₗₛ₁ and Lₗₛ₂ are a leakage inductances of the secondary windings, and C_{snubber} is a capacitance of the snubber capacitance.

16. The DCDC converter according to claim 10, wherein a transmitted power is reduced given a duty cycle above 0.5.

17. The DC/DC converter according to claim 16, wherein the transmitted power is reduced by way of an output current being reduced.
